(19) United States
(12) Patent Application Publication
(10) Pub. No.: US 2018/0033109 A1
(43) Pub. Date: Feb. 1, 2018

(54) USING PUBLIC SAFETY DATA TO MANAGE A CRIMINAL EVENT RESPONSE

(71) Applicant: International Business Machines Corporation, Armonk, NY (US)

(72) Inventors: Robert J. Fund, Tucson, AZ (US); William J. Oliver, Tucson, AZ (US)

(21) Appl. No.: 15/219,671

(22) Filed: Jul. 26, 2016

(51) Int. Cl. G06Q 50/26; G01C 21/36; B64C 39/02; G01C 21/34

(52) U.S. Cl. CPC G06Q 50/265; G01C 21/3407; G01C 21/3484; G01C 21/3492; G01C 21/3667; B64C 39/024; B64C 2201/12

(57) ABSTRACT

Disclosed aspects relate to criminal event response management using a set of public safety data. An origin location of a criminal event can be received. The criminal event may have individual(s). Based on the origin location and the set of public safety data with respect to the criminal event a set of candidate target locations for the individual(s) can be identified. Using the origin location and the set of candidate target locations, a set of candidate routes—from the origin location to the set of candidate target locations—may be computed. Based on a set of relationships of the set of candidate routes, determination(s) may be made with respect to a set of predicted locations for the individual(s) and a set of suggested public safety officer positions. Accordingly, the set of predicted locations for the individual(s) and the set of suggested public safety officer positions may be provided.

### BACKGROUND

This disclosure relates generally to computer systems and, more particularly, relates to managing data associated with a criminal event. Managing criminal event response may be desired to be performed as efficiently as possible. The amount of data that needs to be managed by enterprises related to public safety and criminal events is increasing. As data needing to be managed increases, the need for management efficiency may increase.

### SUMMARY

Aspects of the disclosure relate to using data associated with criminal history information, street networks, criminal behavior, and graphical user interfaces in order to efficiently predict likely destinations and routes for a set of individuals who correspond to a criminal event. For example, a set of candidate routes can be determined because, in general, a fleeing bank robber may make a right-hand turn out of the bank parking lot, may avoid u-turns, and may be likely to head towards the closest highway. In addition, by combining such information with traffic information, construction information, as well as non-street-network information such as physical descriptions of the set of individuals, criminal history, and the like, aspects of the disclosure may be useful to accurately determine likely candidate routes that the set of individuals may take. In certain embodiments, likely destinations of the set of individuals may be discerned using aspects described herein.

Aspects of the disclosure relate to criminal event response management using a set of public safety data. An origin location of a criminal event can be received. The criminal event may have a set of individuals. Based on the origin location and the set of public safety data with respect to the criminal event a set of candidate target locations for the set of individuals can be identified. Using the origin location and the set of candidate target locations, a set of candidate routes—from the origin location to the set of candidate target locations—may be computed. Based on a set of relationships of the set of candidate routes, determination(s) may be made with respect to a set of predicted locations for the set of individuals and a set of suggested public safety officer positions. Accordingly, the set of predicted locations for the set of individuals and the set of suggested public safety officer positions may be provided. Various performance or efficiency benefits may result.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a high-level block diagram of a computer system for implementing various embodiments of the present disclosure.

FIG. 2 is a diagrammatic illustration of an example computing environment according to embodiments.

FIG. 3 is a flowchart illustrating a method for criminal event response management using a set of public safety data according to embodiments.

FIG. 4 is a flowchart illustrating a method for criminal event response management using a set of public safety data according to embodiments.

FIG. 5 shows an example use-case of criminal event response management using a set of public safety data according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to using data associated with criminal history information, street networks, criminal behavior, and graphical user interfaces in order to efficiently predict likely destinations and routes for a set of individuals who correspond to a criminal event. For example, a set of candidate routes can be determined because, in general, a fleeing bank robber may make a right-hand turn out of the bank parking lot, may avoid u-turns, and may be likely to head towards the closest highway. In addition, by combining such information with traffic information, construction information, as well as non-street-network information such as physical descriptions of the set of individuals, criminal history, and the like, aspects of the disclosure may be useful to accurately determine likely candidate routes that the set of individuals may take. In certain embodiments, likely destinations of the set of individuals may be discerned using aspects described herein.

In recent years, there have been thousands of bank robberies in the United States. In general, only slightly more than half of the individuals responsible were identified. When a bank robbery occurs, a typical response by law enforcement may be a “bullseye” strategy. According to such strategy, law enforcement situates themselves at varying distances from the bank in hopes to catch the suspects. Such a methodology may be inefficient and can have a low probability of finding the set of individuals. As time elapses, the probability of finding the suspects may decrease further since the number of streets and destinations becomes too great to effectively monitor. Having the ability to predict which routes a set of individuals is likely to take, and furthermore, knowing potential destinations or hideouts of a bank robber, may reduce the number of resources and officers needed to monitor for escaping vehicles. Accordingly, the probability of catching the suspects quickly may increase. Aspects of the disclosure may predict a set of candidate routes for the set of individuals, predict a set of potential destinations, and provide a set of suggested public safety officer positions.

Aspects of the disclosure include a method, system, and computer program product for criminal event response management using a set of public safety data such as COPLINK (trademark of International Business Machines Corporation) or the like. An origin location of a criminal event can be received. The criminal event may have a set of individuals. Based on the origin location and the set of public safety data with respect to the criminal event a set of candidate target locations for the set of individuals can be identified. Using the origin location and the set of candidate target locations, a set of candidate routes—from the origin location to the set of candidate target locations—may be computed. Based on a set of relationships of the set of candidate routes, determination(s) may be made with respect to a set of predicted locations for the set of individuals and a set of suggested public safety officer positions. Accordingly, the set of predicted locations for the set of individuals and the set of suggested public safety officer positions may be provided.

In embodiments, the set of public safety data can be examined for residence data of a set of persons with a historical record corresponding to the criminal event within a threshold distance of the origin location. In certain embodiments, a subset of the set of persons which have a physical description that corresponds to a reported physical description from the criminal event may be selected. The set of candidate target locations can include at least one of: a set of freeway exits, a set of freeway on-ramps within a threshold proximity of the origin location, a set of city entrances, a set of city exits, a set of rental car facilities, a set of transportation facilities, a set of airports, a set of bus stops, or a set of train stops. The set of candidate routes can include at least one of: a set of property exits from the origin location, a set of routes that uses a turn-propensity weight to indicate a right-hand turn likelihood which exceeds a left-hand turn likelihood, a specific route that uses a u-turn weight to indicate a threshold u-turn likelihood which exceeds a specific u-turn likelihood for the specific route, a set of road construction factors, or a batch of routes that uses a road-segment weight to indicate a major road-segment likelihood which exceeds a minor road-segment likelihood.

In embodiments, a set of temporal factors is evaluated. The set of temporal factors can include at least one of: a quantity of time since the criminal event, a set of estimated travel times, or a time of day. In embodiments, providing the set of predicted locations for the set of individuals and the set of suggested public safety officer positions includes presenting a set of visual indicators. In various embodiments, presenting the set of visual indicators includes displaying a color-coded heat map. In certain embodiments, displaying the color-coded heat map includes modifying, in a dynamic fashion based on a set of updated information, the color-coded heat map to indicate a change in the set of predicted locations for the set of individuals and the set of suggested public safety officer positions. Altogether, performance or efficiency benefits (e.g., reliability, speed, flexibility, responsiveness, stability, resource usage, productivity) may result from aspects described herein. Accordingly, aspects may save resources such as bandwidth, processing, or memory.

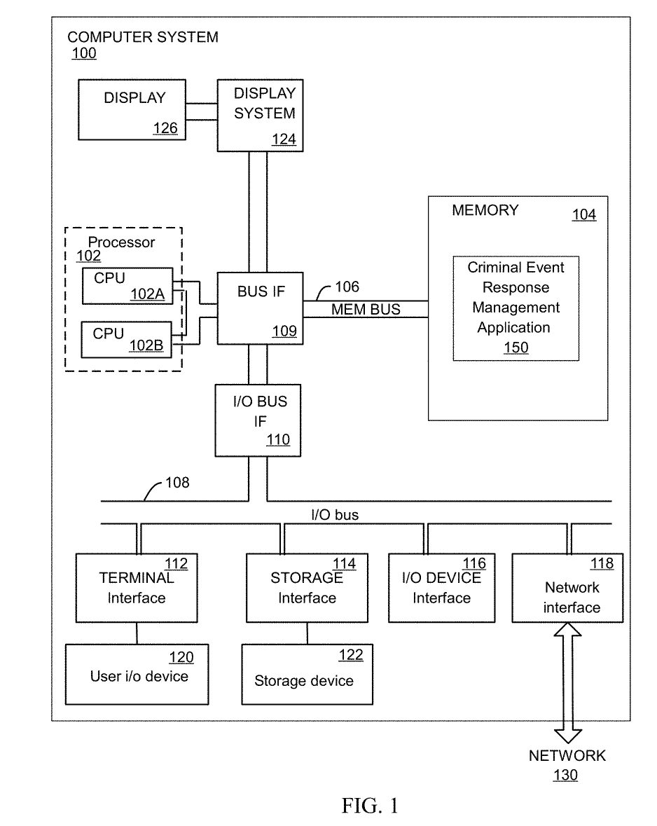

Turning now to the figures, FIG. 1 depicts a high-level block diagram of a computer system for implementing various embodiments of the present disclosure, consistent with various embodiments. The mechanisms and apparatus of the various embodiments disclosed herein apply equally to any appropriate computing system. The major components of the computer system 100 include one or more processors 102, a memory 104, a terminal interface 112, a storage interface 114, an I/O (Input/Output) device interface 116, and a network interface 118, all of which are communicatively coupled, directly or indirectly, for inter-component communication via a memory bus 106, an I/O bus 108, bus interface unit 109, and an I/O bus interface unit 110.

The computer system 100 may contain one or more general-purpose programmable central processing units (CPUs) 102A and 102B, herein generically referred to as the processor 102. In embodiments, the computer system 500 may contain multiple processors; however, in certain embodiments, the computer system 100 may alternatively be a single CPU system. Each processor 102 executes instructions stored in the memory 104 and may include one or more levels of on-board cache.

In embodiments, the memory 104 may include a random-access semiconductor memory, storage device, or storage medium (either volatile or non-volatile) for storing or encoding data and programs. In certain embodiments, the memory 104 represents the entire virtual memory of the computer system 100, and may also include the virtual memory of other computer systems coupled to the computer system 100 or connected via a network. The memory 104 can be conceptually viewed as a single monolithic entity, but in other embodiments the memory 104 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 104 may store all or a portion of the various programs, modules and data structures for processing data transfers as discussed herein. For instance, the memory 104 can store a criminal event response management application 150. In embodiments, the criminal event response management application 150 may include instructions or statements that execute on the processor 102 or instructions or statements that are interpreted by instructions or statements that execute on the processor 102 to carry out the functions as further described below. In certain embodiments, the criminal event response management application 150 is implemented in hardware via semiconductor devices, chips, logical gates, circuits, circuit cards, and/or other physical hardware devices in lieu of, or in addition to, a processor-based system. In embodiments, the criminal event response management application 150 may include data in addition to instructions or statements.

The computer system 100 may include a bus interface unit 109 to handle communications among the processor 102, the memory 104, a display system 124, and the I/O bus interface unit 110. The I/O bus interface unit 110 may be coupled with the I/O bus 108 for transferring data to and from the various I/O units. The I/O bus interface unit 110 communicates with multiple I/O interface units 112, 114, 116, and 118, which are also known as I/O processors (IOPs) or I/O adapters (IOAs), through the I/O bus 108. The display system 124 may include a display controller, a display memory, or both. The display controller may provide video, audio, or both types of data to a display device 126. The display memory may be a dedicated memory for buffering video data. The display system 124 may be coupled with a display device 126, such as a standalone display screen, computer monitor, television, or a tablet or handheld device display. In one embodiment, the display device 126 may include one or more speakers for rendering audio. Alternatively, one or more speakers for rendering audio may be coupled with an I/O interface unit. In alternate embodiments, one or more of the functions provided by the display system 124 may be on board an integrated circuit that also includes the processor 102. In addition, one or more of the functions provided by the bus interface unit 109 may be on board an integrated circuit that also includes the processor 102.

The I/O interface units support communication with a variety of storage and I/O devices. For example, the terminal interface unit 112 supports the attachment of one or more user I/O devices 120, which may include user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 120 and the computer system 100, and may receive output data via the user output devices. For example, a user interface may be presented via the user I/O device 120, such as displayed on a display device, played via a speaker, or printed via a printer.

The storage interface 114 supports the attachment of one or more disk drives or direct access storage devices 122 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 122 may be implemented via any type of secondary storage device. The contents of the memory 104, or any portion thereof, may be stored to and retrieved from the storage device 122 as needed. The I/O device interface 116 provides an interface to any of various other I/O devices or devices of other types, such as printers or fax machines. The network interface 118 provides one or more communication paths from the computer system 100 to other digital devices and computer systems; these communication paths may include, e.g., one or more networks 130.

Although the computer system 100 shown in FIG. 1 illustrates a particular bus structure providing a direct communication path among the processors 102, the memory 104, the bus interface 109, the display system 124, and the I/O bus interface unit 110, in alternative embodiments the computer system 100 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 110 and the I/O bus 108 are shown as single respective units, the computer system 100 may, in fact, contain multiple I/O bus interface units 110 and/or multiple I/O buses 108. While multiple I/O interface units are shown, which separate the I/O bus 108 from various communications paths running to the various I/O devices, in other embodiments, some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 may be implemented as a desktop computer, portable computer, laptop or notebook computer, tablet computer, pocket computer, telephone, smart phone, or any other suitable type of electronic device.

FIG. 1 depicts several major components of the computer system 100. Individual components, however, may have greater complexity than represented in FIG. 1, components other than or in addition to those shown in FIG. 1 may be present, and the number, type, and configuration of such components may vary. Several particular examples of additional complexity or additional variations are disclosed herein; these are by way of example only and are not necessarily the only such variations. The various program components illustrated in FIG. 1 may be implemented, in various embodiments, in a number of different manners, including using various computer applications, routines, components, programs, objects, modules, data structures, etc., which may be referred to herein as “software,” “computer programs,” or simply “programs.”

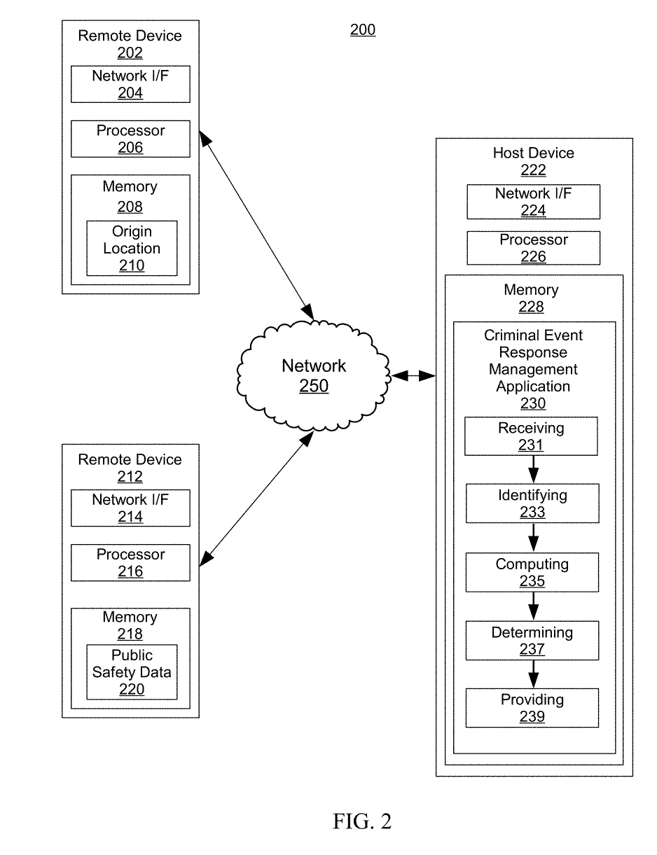

FIG. 2 is a diagrammatic illustration of an example computing environment 200, consistent with embodiments of the present disclosure. In certain embodiments, the environment 200 can include one or more remote devices 202, 212 and one or more host devices 222. Remote devices 202, 212 and host device 222 may be distant from each other and communicate over a network 250 in which the host device 222 comprises a central hub from which remote devices 202, 212 can establish a communication connection. Alternatively, the host device and remote devices may be configured in any other suitable relationship (e.g., in a peer-to-peer or other relationship).

In certain embodiments the network 250 can be implemented by any number of any suitable communications media (e.g., wide area network (WAN), local area network (LAN), Internet, Intranet, etc.). Alternatively, remote devices 202, 212 and host devices 222 may be local to each other, and communicate via any appropriate local communication medium (e.g., local area network (LAN), hardwire, wireless link, Intranet, etc.). In certain embodiments, the network 250 can be implemented within a cloud computing environment, or using one or more cloud computing services. Consistent with various embodiments, a cloud computing environment can include a network-based, distributed data processing system that provides one or more cloud computing services. In certain embodiments, a cloud computing environment can include many computers, hundreds or thousands of them, disposed within one or more data centers and configured to share resources over the network.

Consistent with various embodiments, host device 222 and remote devices 202, 212 may be computer systems preferably equipped with a display or monitor. In certain embodiments, the computer systems may include at least one processor 206, 216, 226 memories 208, 218, 228 and/or internal or external network interface or communications devices 204, 214, 224 (e.g., modem, network cards, etc.), optional input devices (e.g., a keyboard, mouse, or other input device), and other commercially available and custom software (e.g., browser software, communications software, server software, natural language processing software, search engine and/or web crawling software, filter modules for filtering content based upon predefined criteria, etc.). In certain embodiments, the computer systems may include server, desktop, laptop, and hand-held devices.

In certain embodiments, remote devices 202, 212 may include an origin location 210 and a set of public safety data 220. The origin location 210 and the set of public safety data 220 may include information about a criminal event and various public safety information which is configured to be communicated to the host device 222 for processing. As described herein, a criminal event response management application 230 of the host device 222 may be configured to utilize the origin location 210 and the set of public safety data 220. The criminal event response management application 230 may have a set of operations. The set of operations can include a receiving operation 231, an identifying operation 233, a computing operation 235, a determining operation 237, and a providing operation 239.

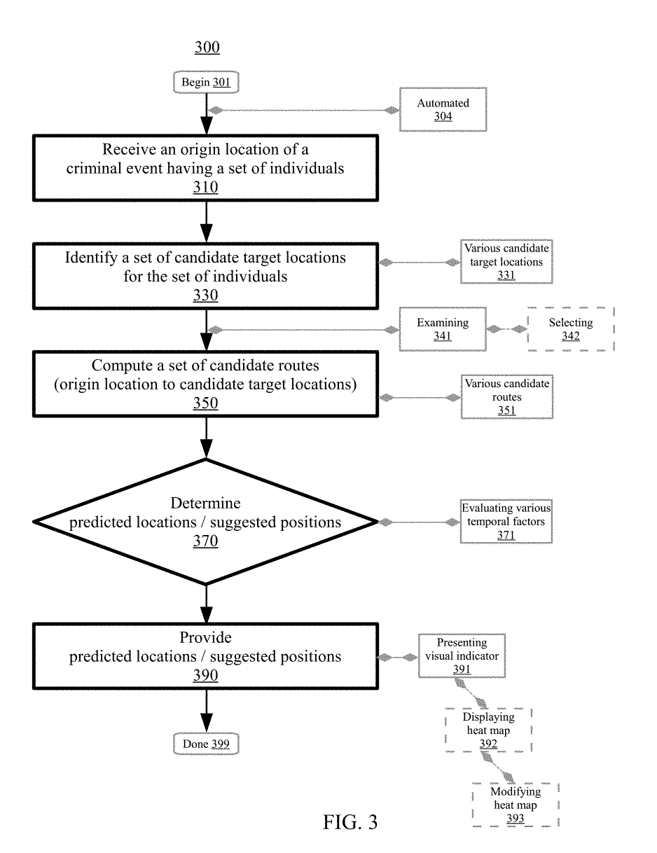

FIG. 3 is a flowchart illustrating a method 300 for criminal event response management using a set of public safety data (e.g., COPLINK) according to embodiments. Method 300 may begin at block 301. In embodiments at block 304, the operational steps such as the receiving, the identifying, the computing, the determining, and the providing each occur in an automated fashion without user intervention or manual action (e.g., using automated computing machinery, fully machine-driven without manual stimuli). The automated operational steps may be performed by a management engine (e.g., as part of a criminal event response management application).

At block 310, an origin location of a criminal event is received. The criminal event has a set of individuals (e.g., one or more persons of interest, accomplices, potential criminals). Receiving can include detecting, sensing, accepting as an input, or otherwise accepting delivery of the origin location. The origin location can include an address (e.g., geographical, street address), a set of coordinates, or the like. For example, the origin location of a bank robbery may include the address of the bank, a specific Automated Teller Machine (ATM), a particular drive-up window/lane, or the like. The origin location may indicate a most recent spot a vehicle or the set of individuals were spotted (e.g., an eyewitness or video indicates the origin location to be an exit behind the building from drive-up lane number two).

At block 330, a set of candidate target locations for the set of individuals is identified. The set of candidate target locations is based on the origin location and the set of public safety data with respect to the criminal event. The set of candidate target locations can include one or more possible destinations. For example, the set of candidate target locations may include a local hideout for the set of individuals or an exit area. In embodiments at block 331, the set of candidate target locations (e.g., using a geographic repository) includes at least one of: a set of freeway exits (e.g., nearest five exits), a set of freeway on-ramps within a threshold proximity of the origin location (e.g., with ten miles), a set of city entrances (e.g., neighboring city entryways), a set of city exits (e.g., locations to depart a relatively confined area), a set of rental car facilities, a set of transportation facilities, a set of airports, a set of bus stops, a set of train stops, or the like.

In embodiments, the identifying operation can include examining the set of public safety data at block 341. The set of public safety data may be examined for residence data of a set of persons with a historical record corresponding to the criminal event within a threshold distance of the origin location. Examining can include scanning, inspecting, analyzing, parsing, querying, deciphering, or the like. To illustrate, the set of candidate target locations can include residences of persons with prior criminal records (e.g., historical data in the set of public safety data which indicates the suspected crime-type such as robbery) within a threshold distance (e.g., two miles) of the origin location. The set of candidate target locations can include locations of associated-individuals such as significant-others, friends, colleagues, co-workers, family, or the like.

In embodiments, the identifying operation can (further) include selecting a subset of the set of persons which have a physical description that corresponds to a reported physical description from the criminal event at block 342. Selecting can include choosing, saving a data value, entering an input digit/character, or the like. The physical description may relate to an individual (e.g., directly recorded in the set of public safety data as a subject of an event) or an associated-individual (e.g., indirectly part of the set of public safety data in notes of an event though not a subject individual of the event). For instance, associated-individuals can include individuals which correspond to a physical description (e.g., make/model of vehicle, estimated height/weight of individuals). Associated-individuals may include individuals which correspond to the location/address (e.g., physical description matches that of a sibling of an individual indicated to have a prior criminal record that has the same address).

At block 350, a set of candidate routes is computed. The set of candidate routes may be from the origin location to the set of candidate target locations. The set of candidate routes can be computed using the origin location and the set of candidate target locations (e.g., using public/private roads from a first coordinate/address to a second coordinate/address). Computing can include ascertaining, resolving, formulating, or calculating. For example, various routes (e.g., travel/transportation paths/courses) may be computed from the origin location to one or more (e.g., each) of the candidate target locations (e.g., possible/likely destinations). In embodiments at block 351, the set of candidate routes includes at least one of: a set of property exits from the origin location (e.g., to indicate an initial direction), a set of routes that uses a turn-propensity weight to indicate a right-hand turn likelihood which exceeds a left-hand turn likelihood (e.g., right-hand turns being more frequent/likely than left-hand turns), a specific route that uses a u-turn weight to indicate a threshold u-turn likelihood which exceeds a specific u-turn likelihood for the specific route (e.g., generally disfavoring/avoiding routes which prefer/require u-turns), a set of road construction factors (e.g., disfavoring routes which may be hindered or cause delays by public works projects), or a batch of routes that uses a road-segment weight to indicate a major road-segment likelihood which exceeds a minor road-segment likelihood (e.g., favor major thoroughfares/streets which both have generally faster typical speeds and more traffic to blend with). For example a variety of such factors may be weighted in compiling the set of candidate routes.

At block 370, a set of predicted locations for the set of individuals and a set of suggested public safety officer positions may be determined. The determination(s) can be made based on a set of relationships of the set of candidate routes. The set of relationships may include, correspond to, derive-from, or arise-out-of various comparisons of routes to find similar or overlapping characteristics, features, or locations (e.g., a number of routes match/overlap by utilizing the same block of a particular street). Direction of traffic flow may or may not be accounted for (e.g., heading east on the same block or heading in either direction on the same block). Determining can include ascertaining, resolving, evaluating, formulating, calculating, comparing, or the like.

The set of predicted locations for the set of individuals can include one or more geographical positions having probabilities assigned to each predicted location. When multiple individuals are involved, the predicted locations may be developed for each individual, for the group as a whole, or various subsets. The predicted locations may include likelihoods of the individuals having already arrived at potential destinations. In general, the set of predicted locations will indicate particular spots on the set of candidate routes. Accordingly, overlaps in spots by a plurality of candidate routes may indicate a higher likelihood of the individual(s) having been there, being there, or on their way there. In embodiments, the determining operation includes evaluating a set of temporal factors at block 371. The set of temporal factors can include at least one of: a quantity of time since the criminal event (e.g., a time duration of how long since the robbery concluded), a set of estimated travel times (e.g., lighter traffic, heavier traffic, construction factors, weather factors), a time of day (e.g., morning traffic patterns, afternoon traffic patterns), or the like.

The set of suggested public safety officer positions may include particular locations for units to be deployed to. Such positions may include various types including motorcycle positions, car positions, helicopter positions, blockade/checkpoint positions, unmanned aerial vehicle positions, areas to initiate dog-sniffing techniques, citizen-observer positions or the like. The various types may be weighted based on factors described herein (e.g., with respect to the set of predicted locations for the set of individuals). Generally, suggested public safety officer positions may relate to intersections where multiple candidate routes overlap. An indication of expected direction of travel may be included for use by the public safety officers. For example, the set of suggested public safety officer may indicate to place one police car at a first intersection of two main thoroughfares, an unmanned aerial vehicle to observe two different freeway exits, and call for volunteer citizen-observer to watch a one-way side-street. Other possibilities are contemplated.

At block 390, the set of predicted locations for the set of individuals and the set of suggested public safety officer positions can be provided. Providing can include transmitting, sending, conveying, displaying, presenting, messaging, publishing, notifying, or the like. A management engine may perform the providing operation by interacting with one or more other computing devices (e.g., sending data from the management engine to a smartphone). Data communicated as part of the providing operation may be encrypted such that it is protected during transmission to a set of target computing devices (e.g., in contrast to over the air radio waves such that the set of individuals can less easily ascertain what is being communicated with respect to positioning).

In embodiments, the providing operation includes presenting a set of visual indicators (e.g., various text, various shapes, various symbols, various colors, various brightness, various contrast) at block 391. In various embodiments, presenting the set of visual indicators includes displaying a color-coded heat map (e.g., flashing bright red being a set of most likely locations, spotty faded green being a set of lesser likely locations) at block 392. In certain embodiments, displaying the color-coded heat map includes modifying the color-coded heat map (e.g., enabling introduction of a time-loop view similar to weather-radar) at block 393. The color-coded heat map may be modified in a dynamic fashion based on a set of updated information (e.g., modifying the color-coded heat map dynamically in real-time on-the-fly). Such modification may indicate a change in the set of predicted locations for the set of individuals (e.g., indicating a higher likelihood that a destination has been reached as time moves on) and the set of suggested public safety officer positions (e.g., indicating for at least one of the public safety officer positions to change such as having an unmanned aerial vehicle patrol a different set of freeway exits).

Method 300 concludes at block 399. Aspects of method 300 may provide performance or efficiency benefits for criminal event response management using a set of public safety data. For example, aspects of method 300 may include positive impacts on flexibility and responsiveness when public safety entities respond to a criminal event. Altogether, performance or efficiency benefits when managing a criminal event response may occur (e.g., speed, flexibility, responsiveness, resource usage).

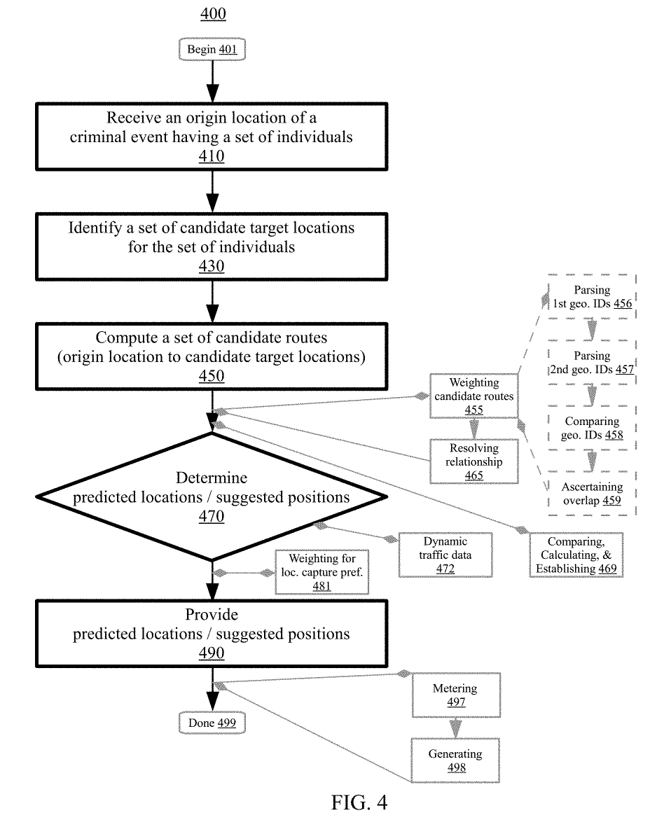

FIG. 4 is a flowchart illustrating a method 400 for criminal event response management using a set of public safety data (e.g., COPLINK) according to embodiments. Aspects of method 400 may be similar or the same as aspects of method 300. Aspects of the method 400 may substantially correspond to other embodiments described herein, including FIGS. 1-5 and the related descriptions. Method 400 may begin at block 401.

At block 410, an origin location of a criminal event can be received. The criminal event may have a set of individuals. At block 430, based on the origin location and the set of public safety data with respect to the criminal event a set of candidate target locations for the set of individuals can be identified. At block 450, using the origin location and the set of candidate target locations, a set of candidate routes—from the origin location to the set of candidate target locations—may be computed. At block 470, based on a set of relationships of the set of candidate routes, determination(s) may be made with respect to a set of predicted locations for the set of individuals and a set of suggested public safety officer positions. Accordingly, the set of predicted locations for the set of individuals and the set of suggested public safety officer positions may be provided at block 490.

In embodiments, the set of candidate routes may be weighted at block 455. The set of candidate routes can be weighted based on a mapping technique. The mapping technique may indicate a portion of a plurality of routes which overlap (i.e., an overlapping route). Generally, weighting can include assigning a greater or lesser amount of importance, emphasis, or impact to one or more candidate routes. In embodiments, a heavier weight (e.g., greater relative importance) may be assigned to candidate routes that overlap (e.g., share coordinates, shared path) with other candidate routes. The more candidate routes overlap (e.g., more shared coordinates, longer shared path), the heavier the assigned weight may be. For example, if a first route uses Main Street only between A Avenue and B Avenue (e.g., one block) and a second route uses Main Street between A Avenue and D Avenue (e.g., three blocks), each of the first and second routes may be weighted because of the shared one block (e.g., between A Avenue and B Avenue). In addition, if a third route uses Main Street between A Avenue and F Avenue (e.g., five blocks), both the second and third routes may be weighted heavier than the first route due to a more extensive/longer shared path.

In various embodiments, the mapping technique which indicates the overlapping route can include a set of mapping operations. A first set of geographical identifiers of a first route may be parsed, extracted, or deciphered at block 456. A second set of geographical identifiers of a second route may be parsed, extracted, or deciphered at block 457. The first and second set of geographical identifiers can be compared at block 458 to indicate a hit count of a common geographical area. For instance, a hit count may be incremented when geographical identifiers match within a threshold (e.g., are identical, are within a 5% radius by distance of a local city block). Based on the comparing, the overlapping route may be ascertained (e.g., existence of the overlapping route, a nature of the overlapping route such as to a form or degree) at block 459. Ascertainment of the overlapping route can occur or be indicated when a hit count for a given area (e.g., for a particular city block, for a given freeway exit) exceeds a threshold value (e.g., more than one route uses the given freeway exit, more than three routes include a certain side-street).

In embodiments, the set of relationships is resolved based on the weighting at block 465. Resolving can include ascertaining, evaluating, formulating, calculating, or the like. The set of relationships can indicate a likelihood of travel. For example, it may be more likely that the set of individuals travel on overlapping portions of routes which overlap relative to non-overlapping portions of routes or routes which do not overlap with other routes. More highly weighted areas may indicate a usefulness of placing public safety officer positions in such highly weighted areas (or certain types of public safety officers). Lesser weighted areas may indicate a different (e.g., lesser) presence of suggested public safety officer positions (or certain types of public safety officers) in the less weighted areas.

In embodiments, the set of relationships of the set of candidate routes includes a set of relationship operations at block 469. A plurality of single candidate routes of the set of candidate routes may be compared with respect to proximity (e.g., geographic nearness, temporal similarity). Based on the comparing, a set of probabilities for a set of segments of the set of candidate routes can be calculated (e.g., using an arithmetic mean, using a clustering technique). Based on the set of probabilities for the set of segments of the set of candidate routes, the set of relationships may be established (e.g., by weighting probabilities of the set of segments, using other environmental factors such as weather or traffic).

In embodiments, determining, based on the set of relationships of the set of candidate routes, the set of predicted locations for the set of individuals and the set of suggested public safety officer positions includes a set of determination operations at block 472. A set of dynamic traffic data (e.g., real-time roadway/vehicle flow/bottleneck information) may be retrieved (e.g., acquired from public safety officers in various positions, pulled from another source). The set of dynamic traffic data can be analyzed. For instance, analyzing can include examining (e.g., performing an inspection), scanning (e.g., reviewing a sample), evaluating (e.g., generating an appraisal), dissecting (e.g., scrutinizing an attribute), searching (e.g., exploring for a reason/ground/motivation), classifying (e.g., assigning a designation), or categorizing (e.g., organizing by a feature). Data analysis may include a process of inspecting, cleaning, transforming, or modeling data to discover useful information, suggest conclusions, or support decisions. Data analysis can extract information/patterns from a data set and transform/translate it into an understandable structure (e.g., a data report which can be provided/furnished) for further use. Using the analyzing, the set of predicted locations for the set of individuals and the set of suggested public safety officer positions can be formulated, calculated, or ascertained (e.g., based on a pattern which is transformed into position indicators).

In embodiments, the set of suggested public safety officer positions may be weighted based on a private location capture preference at block 481. For instance, it may be preferable to approach or capture the set of individuals at a private residence or hideout rather than in a public space (e.g., for safety reasons). Accordingly, the set of suggested public safety officer positions may use a weighting technique which incorporates a likelihood of bystanders in an area. As such, private locations may be weighted greater than public places (e.g., weighting an individual's residence greater than a public park or stadium). Accordingly, different types of public safety officers may be indicated to be placed differently (e.g., using unmanned aerial vehicles in spaces with larger numbers of people to monitor the set of individuals while using public safety personnel nearer to the individual's potential hideout).

In certain embodiments, a usage assessment may be generated with respect to the criminal event response management. Use of the criminal event response management may be metered at block 497. For example, productivity improvements may be measured or speed relative to a benchmark (e.g., historical speed of criminal event responses) can be evaluated, etc. Such factors may correlate to charge-back or cost burdens which can be defined in-advance (e.g., utilizing usage tiers) or scaled with respect to a market-rate. An invoice or bill presenting the usage, rendered services, fee, and other payment terms may be generated based on the metered use at block 498. The generated invoice may be provided (e.g., displayed in a dialog box, sent or transferred by e-mail, text message, initiated for traditional mail) to the user for notification, acknowledgment, or payment.

Method 400 concludes at block 499. Aspects of method 400 may provide performance or efficiency benefits for criminal event response management using a set of public safety data. For example, aspects of method 400 may include positive impacts on flexibility and responsiveness when public safety entities respond to a criminal event. Altogether, performance or efficiency benefits when managing a criminal event response may occur (e.g., speed, flexibility, responsiveness, resource usage).

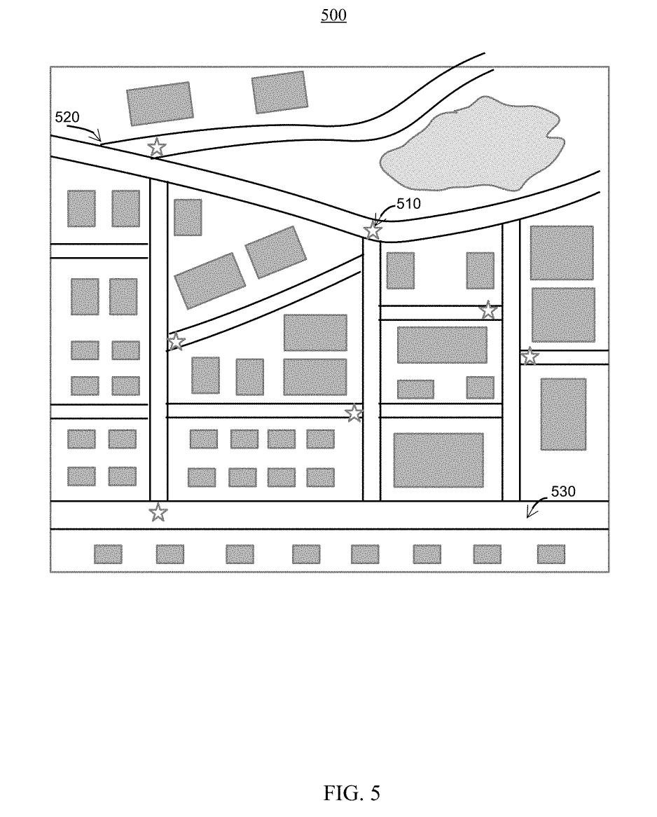

FIG. 5 shows an example use-case of criminal event response management using a set of public safety data according to embodiments. On map 500, the star symbols 510 may represent a set of suggested public safety officer positions in a particular area. Location 520 may represent an exit (or entrance) from a first roadway to a second roadway. Thoroughfare 530 may represent a major route. The star symbols indicating suggested public safety officer positions may be placed at various intersections of key thoroughfares or exits. Map 500 illustrates an example use-case for performance or efficiency benefits as described herein related to criminal event response management.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for criminal event response management using a set of public safety data, the method comprising:
receiving an origin location of a criminal event having a set of individuals;
identifying, based on the origin location and the set of public safety data with respect to the criminal event, a set of candidate target locations for the set of individuals;
computing, using the origin location and the set of candidate target locations, a set of candidate routes from the origin location to the set of candidate target locations;
determining, based on a set of relationships of the set of candidate routes, a set of predicted locations for the set of individuals and a set of suggested public safety officer positions; and
providing the set of predicted locations for the set of individuals and the set of suggested public safety officer positions.

2. The method of claim 1, wherein identifying, based on the origin location and the set of public safety data with respect to the criminal event, the set of candidate target locations for the set of individuals includes:
examining the set of public safety data for residence data of a set of persons with a historical record corresponding to the criminal event within a threshold distance of the origin location.

3. The method of claim 2, wherein identifying, based on the origin location and the set of public safety data with respect to the criminal event, the set of candidate target locations for the set of individuals includes:
selecting a subset of the set of persons which have a physical description that corresponds to a reported physical description from the criminal event.

4. The method of claim 1, wherein the set of candidate target locations is selected from the group consisting of: a set of freeway exits, a set of freeway on-ramps within a threshold proximity of the origin location, a set of city entrances, a set of city exits, a set of rental car facilities, a set of transportation facilities, a set of airports, a set of bus stops, and a set of train stops.

5. The method of claim 1, wherein the set of candidate routes is selected from the group consisting of: a set of property exits from the origin location, a set of routes that uses a turn-propensity weight to indicate a right-hand turn likelihood which exceeds a left-hand turn likelihood, a specific route that uses a u-turn weight to indicate a threshold u-turn likelihood which exceeds a specific u-turn likelihood for the specific route, a set of road construction factors, and a batch of routes that uses a road-segment weight to indicate a major road-segment likelihood which exceeds a minor road-segment likelihood.

6. The method of claim 1, further comprising:
weighting, based on a mapping technique which indicates an overlapping route, the set of candidate routes; and
resolving, based on the weighting, the set of relationships which indicates a likelihood of travel.

7. The method of claim 6, wherein the mapping technique which indicates the overlapping route includes:
parsing a first set of geographical identifiers of a first route;
parsing a second set of geographical identifiers of a second route;
comparing the first and second set of geographical identifiers to indicate a hit count of a common geographical area; and
ascertaining, based on the comparing, the overlapping route.

8. The method of claim 1, wherein determining, based on the set of relationships of the set of candidate routes, the set of predicted locations for the set of individuals and the set of suggested public safety officer positions includes:
evaluating a set of temporal factors.

9. The method of claim 8, wherein the set of temporal factors is selected from the group consisting of: a quantity of time since the criminal event, a set of estimated travel times, and a time of day.

10. The method of claim 1, wherein determining, based on the set of relationships of the set of candidate routes, the set of predicted locations for the set of individuals and the set of suggested public safety officer positions includes:
retrieving a set of dynamic traffic data;
analyzing the set of dynamic traffic data; and
formulating, using the analyzing, the set of predicted locations for the set of individuals and the set of suggested public safety officer positions.

11. The method of claim 1, wherein providing the set of predicted locations for the set of individuals and the set of suggested public safety officer positions includes:
presenting a set of visual indicators.

12. The method of claim 11, wherein presenting the set of visual indicators includes:
displaying a color-coded heat map.

13. The method of claim 12, wherein displaying the color-coded heat map includes:
modifying, in a dynamic fashion based on a set of updated information, the color-coded heat map to indicate a change in the set of predicted locations for the set of individuals and the set of suggested public safety officer positions.

14. The method of claim 1, further comprising:
weighting, based on a private location capture preference, the set of suggested public safety officer positions.

15. The method of claim 1, wherein set of relationships of the set of candidate routes includes:
comparing, with respect to proximity, a plurality of single candidate routes of the set of candidate routes;
calculating, based on the comparing, a set of probabilities for a set of segments of the set of candidate routes; and
establishing, based on the set of probabilities for the set of segments of the set of candidate routes, the set of relationships.

16. The method of claim 1, wherein the receiving, the identifying, the computing, the determining, and the providing each occur in an automated fashion without user intervention.

17. The method of claim 1, further comprising:
metering use of the criminal event response management; and
generating an invoice based on the metered use.

18. A system for criminal event response management using a set of public safety data, the system comprising:
a memory having a set of computer readable computer instructions, and
a processor for executing the set of computer readable instructions, the set of computer readable instructions including:
receiving an origin location of a criminal event having a set of individuals;
identifying, based on the origin location and the set of public safety data with respect to the criminal event, a set of candidate target locations for the set of individuals;
computing, using the origin location and the set of candidate target locations, a set of candidate routes from the origin location to the set of candidate target locations;
determining, based on a set of relationships of the set of candidate routes, a set of predicted locations for the set of individuals and a set of suggested public safety officer positions; and
providing the set of predicted locations for the set of individuals and the set of suggested public safety officer positions.

19. A computer program product for criminal event response management using a set of public safety data, the computer program product comprising a computer readable storage medium having program instructions embodied therewith, wherein the computer readable storage medium is not a transitory signal per se, the program instructions executable by a processor to cause the processor to perform a method comprising:
receiving an origin location of a criminal event having a set of individuals;
identifying, based on the origin location and the set of public safety data with respect to the criminal event, a set of candidate target locations for the set of individuals;
computing, using the origin location and the set of candidate target locations, a set of candidate routes from the origin location to the set of candidate target locations;
determining, based on a set of relationships of the set of candidate routes, a set of predicted locations for the set of individuals and a set of suggested public safety officer positions; and
providing the set of predicted locations for the set of individuals and the set of suggested public safety officer positions.

20. The computer program product of claim 19, wherein at least one of:
the program instructions are stored in the computer readable storage medium in a data processing system, and wherein the program instructions were downloaded over a network from a remote data processing system; or
the program instructions are stored in the computer readable storage medium in a server data processing system, and wherein the program instructions are downloaded over a network to the remote data processing system for use in a second computer readable storage medium with the remote data processing system.
